(19) United States
(12) Patent Application Publication
(10) Pub. No.: US 2018/0273769 A1
(43) Pub. Date: Sep. 27, 2018

(54) POWDER COATING MATERIAL

(71) Applicant: FUJI XEROX CO., LTD., Tokyo (JP)

(72) Inventors: Susumu YOSHINO, Kanagawa (JP); Takeshi AGATA, Kanagawa (JP); Satoshi YOSHIDA, Kanagawa (JP)

(73) Assignee: FUJI XEROX CO., LTD., Tokyo (JP)

(21) Appl. No.: 15/893,781

(22) Filed: Feb. 12, 2018

(30) Foreign Application Priority Data
Mar. 24, 2017 (JP) 2017-058956

(51) Int. Cl. C09D 5/03; C09D 7/62; C09D 167/00; C09D 133/10

(52) U.S. Cl. CPC C09D 5/031; C09D 5/033; C08K 9/06; C09D 167/00; C09D 133/10; C09D 7/62

(57) ABSTRACT

A powder coating material includes powder particles and inorganic particles that are present on surfaces of the powder particles and have an electrical volume resistance of from 1×10⁵ Ω·cm to 1×10¹² Ω·cm.

### CROSS-REFERENCE TO RELATED APPLICATIONS

This application is based on and claims priority under 35 USC 119 from Japanese Patent Application No. 2017-058956 filed Mar. 24, 2017.

### BACKGROUND

### 1. Technical Field

The present invention relates to a powder coating material.

### 2. Related Art

Recently, in a powder coating technology using a powder coating material, the discharge amount of a volatile organic compound (VOC) is reduced in a coating step, and the powder coating material which has not been attached to an object to be coated is collected after coating and is able to be reused, and thus, the powder coating technology has attracted attention from the viewpoint of the global environmental protection. For this reason, various powder coating materials have been studied.

### SUMMARY

According to an aspect of the invention, there is provided a powder coating material, including:

powder particles; and

inorganic particles that are present on surfaces of the powder particles and have an electrical volume resistance of from 1×10⁵ Ω·cm to 1×10¹² Ω·cm.

### DETAILED DESCRIPTION

Hereinafter, exemplary embodiments of the invention will be described in detail.

Powder Coating Material

A powder coating material according to this exemplary embodiment includes powder particles and inorganic particles added on surfaces of the powder particles. Electrical volume resistance of the inorganic particles is 1×10⁵ Ω·cm to 1×10¹² Ω·cm.

The powder coating material used for powder coating is prepared by further adding an external additive (hereinafter will be simply referred to as “external additives”) to the powder particles including, for example, a binder resin, and other components such as a curing agent for curing the binder resin, a colorant such as a pigment, a flame retardant, or a leveling agent used if necessary. The powder coating material thus prepared is applied to an object to be coated by a method such as an electrostatic powder coating method and heated, and therefore a coating film is formed. The electrostatic powder coating method is a method in which the powder coating material charged by contact charging, corona discharging, and the like is discharged (ejected) by using a spray gun, and then the powder coating material is electrostatically attached to an object to be coated, which is grounded.

In the related art, when the coating film is formed on an object to be coated by using the powder coating material, coating film defect (splash marks) occurs in some cases.

With respect to this, according to the powder coating material of the present exemplary embodiment, occurrence of coating film defect (splash marks) of the coating film formed by attaching the powder coating material to an object to be coated and then heating may be prevented.

The reason for this is presumed as below.

When the powder coating material is ejected on an object to be coated and electrostatically attached to thereto, and thus an attachment layer is formed, it is assumed that charges are accumulated in the attachment layer, electrostatic repulsion generated, and thus the coating film defect is caused. The electrostatic repulsion refers that charges are accumulated in the attachment layer and a repulsive force is generated among the powder particles in the attachment layer. It is considered that because of this electrostatic repulsion, the attached powder particles fly off from the attachment layer, craters (splash marks) having a circular shape or a crater shape are formed, and thus the coating film defect occurs.

The inorganic particles of which electrical volume resistance is within the above-described range are externally added to the powder coating material of the present exemplary embodiment. The inorganic particles of which electrical volume resistance is 1×10¹² Ω·cm or less are present on the surfaces of the powder particles, by which charge leakage is likely to occur in the powder coating material, and after the powder coating material is electrostatically attached on the object to be coated, accumulation of charges decreases. As a result, it is presumed that the electrostatic repulsion in the attachment layer is prevented from being generated, and that the powder particles are prevented from flying off from the attachment layer, which may lead to craters (splash marks), so that the coating film defect is prevented.

Meanwhile, because the inorganic particles of which electrical volume resistance is 1×10⁵ Ω·cm or more are present on the surfaces of the powder particles, quantity of electric charges in the attachment layer is not reduced excessively even after the charge leakage is generated. According to this, charges are not reduced excessively in the powder coating material being ejected (discharged) to the object to be coated, and thus electrostatic attachment properties are obtained. Therefore, it is prevented that the powder coating material flies off and then is attached to an unintended area of the object to be coated due to influence of airflow and the like at the time of the ejection, for example. In addition, charges are not reduced excessively in the powder coating material which is electrostatically attached to the object to be coated, and it is prevented that the powder coating material is removed from (peeled off from) the attachment layer due to insufficient charges. Based on this, it is presumed that the powder coating material has an excellent property of forming the coating film.

Electrical Volume Resistance Electrical volume resistance of the inorganic particles used in the present exemplary embodiment is from 1×10⁵ Ω·cm to 1×10¹² Ω·cm, is preferably from 1×10⁶ Ω·cm to 1×10¹¹ Ω·cm, and is more preferably from 1×10⁷ Ω·cm to 1×10¹⁰ Ω·cm.

The electrical volume resistance of the inorganic particles may be regulated by compositions of the inorganic particles, a surface treatment, and the like. For example, by using the inorganic particles which have been subjected to the hydrophobizing treatment at a low degree (more preferably, the inorganic particles not subjected to the hydrophobizing treatment), the electrical volume resistance is likely to be reduced.

The electrical volume resistance of the inorganic particles is measured by the following method.

First, the inorganic particles are separated from the powder particles. Then, the separated inorganic particles which become measurement targets are loaded on a surface of a circular jig with an electrode plate of 20 cm² such that the thickness thereof is from 1 mm to 3 mm, and thus an inorganic particle layer is formed. The same electrode plate of 20 cm² is loaded thereon such that the inorganic particle layer is sandwiched between the electrode plates. In order to remove a space between inorganic particles, after a load of 4 kg is applied on the electrode plate disposed on the inorganic particle layer, the thickness (cm) of the inorganic particle layer is measured. An electrometer and a high-voltage power supply generator are connected to the both electrodes on upper and lower sides of the inorganic particle layer. The electrical volume resistance (Ω·cm) of the inorganic particles is calculated by applying a high voltage to the both electrodes and reading a value (A) of a current flowing at that time. The measurement is carried out under conditions of a temperature of 20° C. and relative humidity of 50%. A calculation expression of the electrical volume resistance (Ω·cm) of the inorganic particles is as follows.

Furthermore, in the expression, ρ, E, I, I₀, and L represent electrical volume resistance (Ω·cm) of inorganic particles, an applied voltage (V), a current value (A), a current value (A) at an applied voltage of 0 V, and a thickness (cm) of an inorganic particle layer, respectively. In this exemplary embodiment, the electrical volume resistance at an applied voltage of 1,000 V is used.

ρ=E×20/(I−I₀)/L Expression:

Content rate of Titanium Oxide in Powder Particles

Titanium oxide is contained in the powder particles as a colorant in some cases. Titanium oxide is conductive particles, and thus as a content of titanium oxide increases, a conductive property of the powder particles also increases, by which the powder coating material becomes a material in which charge leakage is likely to occur. Conversely, in titanium oxide having a small content of the powder particles, a conductive property decreases and the powder coating material becomes a material in which charge leakage is unlikely to occur.

For example, if a content rate of titanium oxide in the powder particles is 2% by weight or less, charge leakage is unlikely to occur. As a result, accumulation of charges becomes easy after the powder coating material is ejected on the object to be coated and then is formed as an attachment layer, and therefore coating film defect (splash marks) is likely to occur. However, according to the present exemplary embodiment, accumulation of charges in the attachment layer is reduced as describe above, and therefore, even if a content rate of titanium oxide in the powder particles is within the above range, coating film defect (splash marks) is prevented from occurring.

Examples of the powder particles in which a content of titanium oxide small (for example, a content rate is within the above range) include powder particles not containing titanium oxide in order to coloration of the powder coating material, and specifically, transparent powder particles (clear powder particles).

Particle Diameter of Powder Particles

If a particle diameter of the powder particles contained in the powder coating material is small (for example, a volume average particle diameter is 10 μm or smaller), a coating film having excellent smoothness may be formed, and also, a surface area of the entirety of the powder coating material increases compared to a case of the powder particles having a larger particle diameter. Therefore, the influence of accumulation of charges becomes bigger, and thus the coating film defect (splash marks) is likely to occur. However, according to the present exemplary embodiment, accumulation of charges in the attachment layer is reduced as described above, and therefore the coating film defect (splash marks) is prevented from occurring.

Attachment Amount in Coating Film

If the coating film formed on the object to be coated becomes thicker, that is, an attachment amount becomes large (for example, attachment amount of 130 g/m² or more), accumulation of charges becomes easier, and therefore, the coating film defect (splash marks) is likely to occur. However, according to the present exemplary embodiment, accumulation of charges in the attachment layer is reduced as described above, and therefore the coating film defect (splash marks) is prevented from occurring.

Silica Particle as External Additive

In the present exemplary embodiment, as an external additive added on the surfaces of the powder particles, it is preferable that silica particle is further added, in addition to the inorganic particles of which the electrical volume resistance is within the above range.

The silica particle is present of the surfaces of the powder particles, and thus fluidity of the powder coating material is improved. According to this, even in a case where the powder particles fly off from the attachment layer due to the electrostatic repulsion, and thus craters are generated, the ejected powder coating material is applied such that open crated portions are filled therewith. Therefore, the coating film defect on the coating film, which is formed over heating (baking) is more easily prevented.

A detailed explanation of the silica particles will be described later.

Average Circularity of Powder Particles

The powder particles preferably have average circularity of 0.97 or more. If the average circularity is within the range, that is, if a form of the powder particles is close to a spherical shape, a surface area of the powder particles is reduced, and therefore a charge amount becomes small. According to this, accumulation of charges in the attachment layer is reduced, and therefore the coating film defect (splash marks) is easily prevented from occurring.

More preferable range and the like of the average circularity of the powder particles will be describe below.

Next, each component of the powder coating material according to the present exemplary embodiment will be explained in detail.

Externally Added Particles

Inorganic Particles

In the powder coating material according to the present exemplary embodiment, the inorganic particles of which the electrical volume resistance is within the range described above is added on the surfaces of the powder particles.

A method for external addition is not particularly limited, and methods for external addition which is known in the powder coating material field may be used.

The preferable examples of the inorganic particles include particles containing TiO₂, Al₂O₃, CuO, ZnO, SnO₂, CeO₂, Fe₂O₃, MgO, BaO, CaO, K₂O, Na₂O, ZrO₂, CaO.SiO₂, K₂O.(TiO₂)ₙ, Al₂O₃.2SiO₂, CaCO₃, MgCO₃, BaSO₄, or MgSO₄.

As the inorganic particles used in this exemplary embodiment, titanium oxide particles or zinc oxide particles are preferable and titanium oxide particles are more preferable, from the viewpoint of preventing the coating film defect of the coating film obtained by the powder coating material.

As the crystal form of the titanium oxide particles, an anatase type and a rutile type are mainly known, and any one of them may be used in this exemplary embodiment. From the viewpoint of light fastness of the coating film, the rutile type is preferable.

In this exemplary embodiment, one type of the inorganic particles may be independently used, and two or more types thereof may be used in combination.

Particle Diameter

The volume average particle diameter (with respect to primary particles) of the inorganic particles is preferably from 10 nm to 100 nm, is more preferably from 15 nm to 90 nm, and is even more preferably from 15 nm to 70 nm.

When the volume average particle diameter of the inorganic particles is within the range described above, attachment properties to the powder particles are excellent, and the coating film defect of the coating film obtained by the powder coating material is prevented.

The volume average particle diameter of the inorganic particles is measured by the following method.

First, the powder coating material which becomes a measurement target is observed by a scanning electron microscope (SEM). Then, each equivalent circle diameter of 100 inorganic particles which become a measurement target is obtained by image analysis, and an equivalent circle diameter having a cumulative percentage of 50% based on volume from a small diameter side in a distribution based on volume is set to a volume average particle diameter.

In the image analysis for obtaining the equivalent circle diameter of 100 inorganic particles which become the measurement target, a two-dimensional image is captured at a magnification of 10,000 times by using an analysis device (ERA-8900: manufactured by ELIONIX INC.), a projected area is obtained in conditions of 0.010000 μm/pixel by using image analysis software WinROOF (manufactured by MITANI CORPORATION), and the equivalent circle diameter is obtained by expression: Equivalent Circle Diameter=2×(Projected Area/π)^{1/2}.

Furthermore, in order to measure the volume average particle diameter of plural types of external additives from the powder coating material, it is necessary to separate each external additive. Specifically, various external additives are subjected to element mapping by using a scanning electron microscope provided with an energy dispersion type X-ray analysis device (SEM-EDX), and an element derived from various external additives is associated with the corresponding external additive, and thus, the external additives are separated.

Aspect Ratio

An aspect ratio of the inorganic particles is preferably from 1 to 5.

If the aspect ratio is within the range described above, the inorganic particles are less likely to be released from the powder particles, and the coating film defect of the coating film obtained is prevented.

The aspect ratio is preferably 1 or more and less than 2 and more preferably from 1 to 1.5, from the viewpoint of further preventing the coating film defect of the coating film.

In addition, the aspect ratio is preferably from 2 to 5 and more preferably from 2.5 to 4.5, from the viewpoint of preventing the release of the inorganic particles from the powder.

The aspect ratio is measured as a ratio (L/S) of a major axis (L) to a minor axis (S) by performing particle shape analysis on an image of the inorganic particles on the powder particles captured by a scanning electron microscope (SEM, manufactured by Hitachi High-Technologies Corporation, product name: SU8010), using auxiliary image analysis software (manufactured by MITANI CORPORATION, product name: WinROOF).

Hydrophobizing Treatment

The surfaces of the inorganic particles used in this exemplary embodiment may be treated with a hydrophobizing agent in advance, but it is preferable to use the inorganic particles which have been subjected to the hydrophobizing treatment at a low degree (more preferably, the inorganic particles not subjected to the hydrophobizing treatment), from the viewpoint of easily regulating the electrical volume resistance of the inorganic particles to be within the range described above. That is, it is preferable to use the inorganic particles which is not excessively treated with a hydrophobizing agent, from the viewpoint of preventing the coating film defect of the coating film obtained by the powder coating material.

The hydrophobizing treatment may be performed by dipping the inorganic particles into a hydrophobizing agent, and the like. The hydrophobizing agent is not particularly limited, and examples of thereof include a silane coupling agent, silicone oil, a titanate coupling agent, and an aluminum coupling agent. One type of the hydrophobizing agent may be independently used, or two or more types thereof may be used in combination.

Content of Inorganic Particles

From the viewpoint of preventing the coating film defect of the coating film obtained by the powder coating material, a content of the inorganic particles (added amount) is preferably from 0.1% by weight to 3% by weight and more preferably from 0.3% by weight to 1.5% by weight, with respect to the total weight of the powder particles.

Silica Particles

In the present exemplary embodiment, as an external additive added on the surfaces of the powder particles, it is preferable that silica particle is further added, in addition to the inorganic particles of which the electrical volume resistance is within the above range. The silica particle is present of the surfaces of the powder particles, and thus fluidity of the powder coating material is improved, and the coating film defect of the coating film is more easily prevented.

As the silica particles, as long as the particles have SiO₂ as a main component, the silica particles may be crystalline or amorphous. In addition, the silica particles may be particles prepared from a silicon compound such as water glass and alkoxysilane as a raw material, or may be particles obtained by pulverizing quartz.

Specifically, examples of the silica particles include sol gel silica particles, aqueous colloidal silica particles, alcoholic silica particles, fumed silica particles obtained by vapor phase method, and fused silica particles.

Hydrophobization degree of Silica Particles

A hydrophobization degree of the silica particles is preferably 60% or less. If a hydrophobization degree is 60% or less, affinity with the binder resin in the powder particles is easily obtained, whereby fusing of the powder coating material is unlikely to be prevented in a case where the attachment layer electrostatically attached to the object to be coated is heated (baked), and thus the coating film having high smoothness may be easily obtained.

A hydrophobization degree of the silica particles is preferably 60% or less, more preferably 50% or less, and further preferably 40% or less.

Regarding a hydrophobization degree of the silica particles, 0.2% by weight of the silica particles as a sample is put in 50 ml of ion-exchanged water, and methanol is added dropwise from a burette while stirring with a magnetic stirrer, and therefore the weight fraction of methanol in the methanol-water mixed solution at the end point where the whole sample sank is obtained as a hydrophobization degree.

Hydrophobizing Treatment

The surfaces of the silica particles used in this exemplary embodiment may be treated with a hydrophobizing agent in advance, but it is preferable to use the inorganic particles which have been subjected to the hydrophobizing treatment at a low degree, from the viewpoint of easily regulating a hydrophobization degree of the silica particles to be within the range described above.

The hydrophobizing treatment may be performed by dipping the silica particles into a hydrophobizing agent. The hydrophobizing agent is not particularly limited, and examples of thereof include a silane coupling agent, silicone oil, a titanate coupling agent, and an aluminum coupling agent. One type of the hydrophobizing agent may be independently used, or two or more types thereof may be used in combination.

Particle Diameter of Silica Particles

A volume average particle diameter (with respect to primary particles) of the silica particles is preferably 5 nm to 120 nm, more preferably 10 nm to 100 nm, and further preferably 12 nm to 80 nm.

If a volume average particle diameter of the silica particles is within the above range, the fluidity of the powder coating material is excellent, and the coating film defect of the coating film is more easily prevented.

Measurement of a volume average particle diameter of the silica particles is performed in accordance with the method for measuring a volume average particle diameter of the inorganic particles.

Content of Silica Particles

As a content (the added amount) of the silica particles, 0.1% by weight to 3.0% by weight is preferable, 0.3% by weight to 2.0% by weight is more preferable with respect to the total weight of the powder particles, from the viewpoint of preventing the coating film defect of the coating film obtained.

Powder Particles

It is preferable that the powder particles contained in the powder coating material contain a thermosetting resin and a thermosetting agent. The powder particles may contain a colorant, and other additives, if necessary.

Thermosetting Resin

The thermosetting resin is a resin including a thermosetting reaction group. In the related art, as the thermosetting resin, various types of resin used in the powder particles of the powder coating material are used.

The thermosetting resin may preferably be a water-insoluble (hydrophobic) resin. When the water-insoluble (hydrophobic) resin is used as the thermosetting resin, environmental dependence of charging characteristics of the powder coating material (powder particle) is decreased. When preparing the powder particle by an aggregation and coalescence method, the thermosetting resin is preferably a water-insoluble (hydrophobic) resin, in order to perform emulsification and dispersion in an aqueous medium. The water-insolubility (hydrophobicity) means a dissolved amount of a target material with respect to 100 parts by weight of water at 25° C. is less than 5 parts by weight.

Examples of the thermosetting resin include at least one selected from the group consisting of a thermosetting polyester resin, a thermosetting (meth)acrylic resin, a thermosetting fluorine resin (for example, a fluoroethylene-vinyl ether (FEVE) copolymer resin, and the like), and a thermosetting polyethylene resin. Among the thermosetting resins, the thermosetting polyester resin is preferable from the viewpoint of easy control of charging series at the time of performing coating, strength of the coating film, excellent finishing properties, and the like.

Examples of the thermosetting reaction group included in the thermosetting polyester resin include an epoxy group, a carboxyl group, a hydroxyl group, an amide group, an amino group, an acid anhydride group, a block isocyanate group, and the like, and the carboxyl group and the hydroxyl group are preferable from the viewpoint of easy synthesis.

Thermosetting Polyester Resin

The thermosetting polyester resin is a polyester resin having a curable reaction group. Examples of a thermosetting reaction group included in the thermosetting polyester resin include an epoxy group, a carboxyl group, a hydroxyl group, an amide group, an amino group, an acid anhydride group, a block isocyanate group, and the like, and the carboxyl group and the hydroxyl group are preferable from the viewpoint of easy synthesis.

The thermosetting polyester resin, for example, is a polycondensate obtained by performing at least polycondensation with respect to a polybasic acid and polyol.

The thermosetting reaction group of the thermosetting polyester resin is introduced by adjusting the use amount of the polybasic acid and the polyol at the time of synthesizing the polyester resin. According to the adjustment, a thermosetting polyester resin having at least one of a carboxyl group and a hydroxyl group is able to be obtained as the thermosetting reaction group.

In addition, the thermosetting polyester resin may be obtained by introducing the thermosetting reaction group after the polyester resin is synthesized.

Examples of polybasic acid include terephthalic acid, isophthalic acid, phthalic acid, methylterephthalic acid, trimellitic acid, pyromellitic acid, or anhydrides thereof; succinic acid, adipic acid, azelaic acid, sebacic acid, or anhydrides thereof; maleic acid, itaconic acid, or anhydrides thereof; fumaric acid, tetrahydrophthalic acid, methyltetrahydrophthalic acid, hexahydrophthalic acid, methylhexahydrophthalic acid, or anhydrides thereof; cyclohexane dicarboxylic acid, 2,6-naphthalene dicarboxylic acid, and the like.

Examples of polyol include ethylene glycol, diethylene glycol, propylene glycol, dipropylene glycol, 1,3-butanediol, 1,4-butanediol, 1,5-pentanediol, 1,6-hexanediol, neopentyl glycol, triethylene glycol, bis-(hydroxyethyl) terephthalate, cyclohexanedimethanol, octanediol, diethylpropane diol, butylethylpropane diol, 2-methyl-1,3-propane diol, 2,2,4-trimethylpentane diol, hydrogenated bisphenol A, an ethylene oxide adduct of hydrogenated bisphenol A, a propylene oxide adduct of hydrogenated bisphenol A, trimethylolethane, trimethylolpropane, glycerin, pentaerythritol, tris-hydroxyethyl isocyanurate, hydroxy pivalyl hydroxy pivalate, and the like.

The thermosetting polyester resin may be obtained by polycondensing other monomer in addition to polybasic acid and polyol.

Examples of the other monomer include a compound including both a carboxylic group and a hydroxyl group in one molecule (for example, dimethanol propionic acid and hydroxy pivalate), a monoepoxy compound (for example, glycidyl ester of branched aliphatic carboxylic acid such as “Cardura E10 (manufactured by Shell)”), various monohydric alcohols (for example, methanol, propanol, butanol, and benzyl alcohol), various monovalent basic acids (for example, benzoic acid and p-tert-butyl benzoate), various fatty acids (for example, castor oil fatty acid, coconut oil fatty acid, and soybean oil fatty acid), and the like.

The structure of the thermosetting polyester resin may be a branched structure or a linear structure.

Regarding the thermosetting polyester resin, the total value of an acid value and a hydroxyl value is preferably from 10 mgKOH/g to 250 mgKOH/g, and the number average molecular weight is preferably from 1,000 to 100,000.

When the total of an acid value and a hydroxyl value is in the range described above, smoothness and mechanical properties of the coating film are easily improved. When the number average molecular weight is in the range described above, smoothness and mechanical properties of the coating film are improved and storage stability of the powder coating material is easily improved.

The measurement of the acid value and the hydroxyl value of the thermosetting polyester resin is performed based on JIS K-0070-1992. In addition, the measurement of the number average molecular weight of the thermosetting polyester resin is performed in the same manner as measurement of the number average molecular weight of the thermosetting (meth)acrylic resin described below.

Thermosetting (Meth)Acrylic Resin

The thermosetting (meth)acrylic resin is a (meth)acrylic resin including a thermosetting reaction group. For the introduction of the thermosetting reaction group to the thermosetting (meth)acrylic resin, a vinyl monomer including a thermosetting reaction group may preferably be used. The vinyl monomer including a thermosetting reaction group may be a (meth)acrylic monomer (monomer having a (meth)acryloyl group), or may be a vinyl monomer other than the (meth)acrylic monomer.

Examples of the thermosetting reaction group of the thermosetting (meth)acrylic resin include an epoxy group, a carboxylic group, a hydroxyl group, an amide group, an amino group, an acid anhydride group, a (block) isocyanate group, and the like. Among these, as the thermosetting reaction group of the (meth)acrylic resin, at least one kind selected from the group consisting of an epoxy group, a carboxylic group, and a hydroxyl group is preferable, from the viewpoint of ease of preparation of the (meth)acrylic resin. Particularly, from the viewpoints of excellent storage stability of the powder coating material and coating film appearance, at least one kind of the thermosetting reaction group is more preferably an epoxy group.

Examples of the vinyl monomer including an epoxy group as the thermosetting reaction group include various chain epoxy group-containing monomers (for example, glycidyl (meth)acrylate, β-methyl glycidyl (meth)acrylate, glycidyl vinyl ether, and allyl glycidyl ether), various (2-oxo-1,3-oxolane) group-containing vinyl monomers (for example, (2-oxo-1,3-oxolane) methyl (meth)acrylate), various alicyclic epoxy group-containing vinyl monomers (for example, 3,4-epoxy cyclohexyl (meth)acrylate, 3,4-epoxycyclohexylmethyl (meth)acrylate, and 3,4-epoxycyclohexylethyl (meth)acrylate), and the like.

Examples of the vinyl monomer including a carboxylic group as the thermosetting reaction group include various carboxylic group-containing monomers (for example, (meth)acrylic acid, crotonic acid, itaconic acid, maleic acid, and fumaric acid), various monoesters of α,β-unsaturated dicarboxylic acid and monohydric alcohol having 1 to 18 carbon atoms (for example, monomethyl fumarate, monoethyl fumarate, monobutyl fumarate, monoisobutyl fumarate, monotert-butyl fumarate, monohexyl fumarate, monooctyl fumarate, mono 2-ethylhexyl fumarate, monomethylmaleate, monoethylmaleate, monobutyl maleate, monoisobutyl maleate, monotert-butyl maleate, monohexyl maleate, monooctyl maleate, and mono 2-ethylhexyl maleate), monoalkyl ester itaconate (for example, monomethyl itaconate, monoethyl itaconate, monobutyl itaconate, monoisobutyl itaconate, monohexyl itaconate, monooctyl itaconate, and mono 2-ethylhexyl itaconate), and the like.

Examples of the vinyl monomer including a hydroxyl group as the thermosetting reaction group include various hydroxyl group-containing (meth)acrylates (for example, 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, 4-hydroxybutyl (meth)acrylate, polyethylene glycol mono(meth)acrylate, and polypropylene glycol mono(meth)acrylate), an addition reaction product of the various hydroxyl group-containing (meth)acrylates and ε-caprolactone, various hydroxyl group-containing vinyl ethers (for example, 2-hydroxyethyl vinyl ether, 3-hydroxypropyl vinyl ether, 2-hydroxypropyl vinyl ether, 4-hydroxybutyl vinyl ether, 3-hydroxybutyl vinyl ether, 2-hydroxy-2-methylpropyl vinyl ether, 5-hydroxypentyl vinyl ether, and 6-hydroxyhexyl vinyl ether), an addition reaction product of the various hydroxyl group-containing vinyl ethers and ε-caprolactone, various hydroxyl group-containing allyl ethers (for example, 2-hydroxyethyl (meth)allyl ether, 3-hydroxypropyl (meth)allyl ether, 2-hydroxypropyl (meth)allyl ether, 4-hydroxybutyl (meth)allyl ether, 3-hydroxybutyl (meth)allyl ether, 2-hydroxy-2-methylpropyl (meth)allyl ether, 5-hydroxypentyl (meth)allyl ether, and 6-hydroxyhexyl (meth)allyl ether), an addition reaction product of the various hydroxyl group-containing allyl ethers and ε-caprolactone, and the like.

In the thermosetting (meth)acrylic resin, another vinyl monomer not including a thermosetting reaction group may be copolymerized, in addition to the (meth)acrylic monomer.

Examples of the other vinyl monomer include various α-olefins (for example, ethylene, propylene, and butene-1), various halogenated olefins except fluoroolefin (for example, vinyl chloride and vinylidene chloride), various aromatic vinyl monomers (for example, styrene, α-methyl styrene, and vinyl toluene), various diesters of unsaturated dicarboxylic acid and monohydric alcohol having 1 to 18 carbon atoms (for example, dimethyl fumarate, diethyl fumarate, dibutyl fumarate, dioctylfumarate, dimethyl maleate, diethyl maleate, dibutyl maleate, dioctyl maleate, dimethyl itaconate, diethyl itaconate, dibutyl itaconate, and dioctyl itaconate), various acid anhydride group-containing monomers (for example, maleic anhydride, itaconic anhydride, citraconic anhydride, (meth)acrylic anhydride, and tetrahydrophthalic anhydride), various phosphoric acid ester group-containing monomers (for example, diethyl-2-(meth)acryloyloxyethyl phosphate, dibutyl-2-(meth)acryloyloxybutyl phosphate, dioctyl-2-(meth)acryloyloxyethyl phosphate, and diphenyl-2-(meth)acryloyloxyethyl phosphate), various hydrolyzable silyl group-containing monomers (for example, γ-(meth)acryloyloxypropyl trimethoxysilane, γ-(meth)acryloyloxypropyl triethoxysilane, and γ-(meth)acryloyloxypropyl methyldimethoxysilane), various vinyl aliphatic carboxylate (for example, vinyl acetate, vinyl propionate, vinyl butyrate, vinyl isobutyrate, vinyl caproate, vinyl caprylate, vinyl caprate, vinyl laurate, branched vinyl aliphatic carboxylate having 9 to 11 carbon atoms, and vinyl stearate), various vinyl ester of carboxylic acid having a cyclic structure (for example, cyclohexane carboxylic acid vinyl, methylcyclohexane carboxylic acid vinyl, vinyl benzoate, and p-tert-butyl vinyl benzoate), and the like.

In the thermosetting (meth)acrylic resin, in the case of using a vinyl monomer other than the (meth)acrylic monomer, as the vinyl monomer including a thermosetting reaction group, an acrylic monomer not including a thermosetting reaction group is used.

Examples of the acrylic monomer not including a thermosetting reaction group include alkyl ester (meth)acrylate (for example, methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-hexyl (meth)acrylate, cyclohexyl (meth)acrylate, 2-ethylhexyl (meth)acrylate, n-octyl (meth)acrylate, isooctyl (meth)acrylate, 2-ethyloctyl (meth)acrylate, dodecyl (meth)acrylate, isodecyl (meth)acrylate, lauryl (meth)acrylate, and stearyl (meth)acrylate), various aryl ester (meth)acrylates (for example, benzyl (meth)acrylate, phenyl (meth)acrylate, and phenoxyethyl (meth)acrylate), various alkyl carbitol (meth)acrylates (for example, ethyl carbitol (meth)acrylate), other various ester (meth)acrylates (for example, isobornyl (meth)acrylate, dicyclopentanyl (meth)acrylate, dicyclopentenyl (meth)acrylate, dicyclopentenyloxyethyl (meth)acrylate, and tetrahydrofurfuryl (meth)acrylate), various amino group-containing amide unsaturated monomers (for example, N-dimethylaminoethyl (meth)acrylamide, N-diethylaminoethyl (meth)acrylamide, N-dimethylaminopropyl (meth)acrylamide, and N-diethylamino propyl (meth)acrylamide), various dialkylaminoalkyl (meth)acrylates (for example, dimethylaminoethyl (meth)acrylate and diethylaminoethyl (meth)acrylate), various amino group-containing monomers (for example, tert-butylaminoethyl (meth)acrylate, tert-butylaminopropyl (meth)acrylate, aziridinylethyl (meth)acrylate, pyrrolidinylethyl (meth)acrylate, and piperidinylethyl (meth)acrylate), and the like.

The thermosetting (meth)acrylic resin is preferably an acrylic resin having a number average molecular weight of from 1,000 to 20,000 (preferably from 1,500 to 15,000).

When the number average molecular weight thereof is in the range described above, smoothness and mechanical properties of the coating film are easily improved.

The weight average molecular weight and the number average molecular weight of the thermosetting (meth)acrylic resin are measured by gel permeation chromatography (GPC). The molecular weight measurement by GPC is performed with a THF solvent using HLC-8120 GPC, which is GPC manufactured by Tosoh Corporation as a measurement device and TSKgel Super HM-M (15 cm), which is a column manufactured by Tosoh Corporation. The weight average molecular weight and the number average molecular weight are calculated using a calibration curve of molecular weight created with a monodisperse polystyrene standard sample from results of this measurement.

The thermosetting resin may be used alone or in combination of two or more kinds thereof.

The content of the thermosetting resin is preferably from 20% by weight to 99% by weight, and more preferably from 30% by weight to 95% by weight, with respect to the total content of the powder particles.

Furthermore, as described below, in a case where the powder particles are core-shell particles, when the thermosetting resin is applied as a resin of a resin coating portion, the content of the thermosetting resin described above indicates the content of the total thermosetting resin of a core and the resin coating portion.

Thermosetting Agent

The thermosetting agent is selected according to the type of thermosetting reaction group of the thermosetting resin.

Here, the thermosetting agent indicates a compound having a functional group which is able to react with the thermosetting reaction group which is a terminal group of the thermosetting resin.

When the thermosetting reaction group of the thermosetting resin is a carboxyl group, examples of the thermosetting agent include various epoxy resins (for example, polyglycidyl ether of bisphenol A), an epoxy group-containing acrylic resin (for example, glycidyl group-containing acrylic resin), various polyglycidylethers of polyol (for example, 1,6-hexanediol, trimethylol propane, and trimethylol ethane), various polyglycidyl esters of polyvalent carboxylic acid (for example, phthalic acid, terephthalic acid, isophthalic acid, hexahydrophthalic acid, methyl hexahydrophthalic acid, trimellitic acid, and pyromellitic acid), various alicyclic epoxy group-containing compounds (for example, bis(3,4-epoxy cyclohexyl) methyl adipate), hydroxy amide (for example, triglycidyl isocyanurate and β-hydroxyalkyl amide), and the like.

When the thermosetting reaction group of the thermosetting resin is a hydroxyl group, examples of the thermosetting agent include blocked polyisocyanate, aminoplast, and the like. Examples of blocked polyisocyanate include organic diisocyanate such as various aliphatic diisocyanates (for example, hexamethylene diisocyanate and trimethyl hexamethylene diisocyanate), various alicyclic diisocyanates (for example, xylylene diisocyanate and isophorone diisocyanate), various aromatic diisocyanates (for example, tolylene diisocyanate and 4,4′-diphenylmethane diisocyanate); an adduct of the organic diisocyanate and polyol, a low-molecular weight polyester resin (for example, polyester polyol), or water; a polymer of the organic diisocyanate (a polymer including isocyanurate-type polyisocyanate compound); various polyisocyanate compounds blocked by a commonly used blocking agent such as isocyanate biuret product; a self-block polyisocyanate compound having a uretdione bond in a structural unit; and the like.

When the thermosetting reaction group of the thermosetting resin is an epoxy group, specific examples of the thermosetting agent include acid such as succinic acid, glutaric acid, adipic acid, pimelic acid, suberic acid, azelaic acid, sebacic acid, dodecanedioic acid, eicosanoic diacid, maleic acid, citraconic acid, itaconic acid, glutaconic acid, phthalic acid, trimellitic acid, pyromellitic acid, tetrahydrophthalic acid, hexahydrophthalic acid, and cyclohexene-1,2-dicarboxylic acid; anhydrides thereof; urethane-modified products thereof; and the like. Among these, as the thermosetting agent, aliphatic dibasic acid is preferably from the viewpoints of a property of the coating film and storage stability, and dodecanedioic acid is particularly preferable from the viewpoint of a property of the coating film.

The thermosetting agent may be used alone or in combination of two or more kinds thereof.

The content of the thermosetting agent is preferably from 1% by weight to 30% by weight and more preferably from 3% by weight to 20% by weight, with respect to the thermosetting resin.

Furthermore, as described below, in the case where the powder particle is a particle having a core-shell structure, when the thermosetting resin is used as the resin of the resin coating portion, the content of the thermosetting agent means the content with respect to the entire thermosetting resin in the core and the resin coating portion.

Colorant

The powder particles may contain a colorant.

As the powder particles, there are powder particles which contain titanium oxide as a colorant and powder particles which does not contain titanium oxide. Titanium oxide is a conductive particle, and therefore the powder particles having a small content of titanium oxide have low conductivity and become a powder coating material in which charge leakage is unlikely to occur. For example, if a content rate of titanium oxide in the powder particles is 2% by weight or less, charge leakage is unlikely to occur. As a result, accumulation of charges becomes easy after the powder coating material is ejected on the object to be coated and then is formed as an attachment layer, and therefore coating film defect (splash marks) is likely to occur. However, according to the present exemplary embodiment, accumulation of charges in the attachment layer is reduced, and therefore, even if a content rate of titanium oxide in the powder particles is within the above range, coating film defect (splash marks) is prevented from occurring.

As a colorant, a pigment is used, for example. As the colorant, a pigment and a dye may be used in combination.

Examples of a pigment include an inorganic pigment such as titanium oxide, iron oxide (for example, colcothar), titanium yellow, zinc white, white lead, zinc sulfide, lithopone, antimony oxide, cobalt blue, and carbon black; an organic pigment such as quinacridone red, phthalocyanine blue, phthalocyanine green, permanent red, Hansa yellow, indanthrene Blue, Brilliant Fast Scarlet, and benzimidazolone yellow; and the like.

In addition, as the pigment, a brilliant pigment is also used. Examples of the brilliant pigment include metal powder such as a pearl pigment, aluminum powder, stainless steel powder; metallic flakes; glass beads; glass flakes; mica; and flake-shaped iron oxide (MIO).

The colorant may be used alone or in combination of two or more kinds thereof.

The content of the colorant is determined depending on types of the pigment, and the hue, brightness, and the depth required for the coating film.

The content of the colorant is, for example, preferably from 1% by weight to 70% by weight and more preferably from 2% by weight to 60% by weight, with respect to the entire resin which constitutes the powder particle.

Here, the powder particles may contain coloring pigments other than the white pigment as the colorant, along with the white pigment. The powder particles contain the coloring pigment and the white pigment, and thus, the color of the surface of the object to be coated is concealed by the coating film, and color developing properties of the coloring pigment are improved. Furthermore, examples of the white pigment include a known white pigment such as titanium oxide, barium sulfate, zinc oxide, and calcium carbonate, and the titanium oxide is preferable from the viewpoint of high whiteness (that is, high concealing properties).

Divalent or More Metal Ion

The powder particles may preferably contain a divalent or more metal ion (hereinafter, also simply referred to as “metal ion”). When the powder particles are the core-shell particles as described below, the metal ion may be a component contained in both of the core and the resin coating portion of the powder particles, or either thereof.

When the divalent or more metal ion is contained in the powder particles, ion-crosslinking is formed due to the metal ion in the powder particles. For example, the ion-crosslinking is formed due to a mutual interaction between the functional group (for example, when the thermosetting polyester resin is used as the thermosetting resin, the carboxyl group or the hydroxyl group of the thermosetting polyester resin) of the thermosetting resin and the metal ion. According to the ion-crosslinking, a phenomenon (so-called bleeding) in which encapsulated substances of the powder particles (the thermosetting agent, and a colorant to be added if necessary, and other additives, in addition to the thermosetting agent) are precipitated on the surface of the powder particles is prevented, and thus, storing properties easily become higher. In addition, in the ion-crosslinking, the bonding of the ion-crosslinking is broken by heating at the time of thermosetting the powder coating material after being coated, and thus, melt viscosity of the powder particles is low, and a coating film having high smoothness is easily formed.

Examples of the metal ion include divalent to tetravalent metal ions. Specifically, examples of the metal ion include at least one type of metal ion selected from the group consisting of aluminum ion, magnesium ion, iron ion, zinc ion, and calcium ion.

Examples of a supply source of the metal ion (a compound contained in the powder particles as an additive) include a metal salt, an inorganic metal salt polymer, a metal complex, and the like. When the powder particles are prepared by an aggregation and coalescence method, the metal salt and the inorganic metal salt polymer, for example, are added to the powder particles as an aggregating agent.

Examples of the metal salt include aluminum sulfate, aluminum chloride, magnesium chloride, magnesium sulfate, iron chloride (II), zinc chloride, calcium chloride, calcium sulfate, and the like.

Examples of the inorganic metal salt polymer include polyaluminum chloride, polyaluminum hydroxide, polyiron sulfate (II), calcium polysulfide, and the like.

Examples of the metal complex include a metal salt of an aminocarboxylic acid, and the like. Specifically, examples of the metal complex include a metal salt (for example, a calcium salt, a magnesium salt, an iron salt, an aluminum salt, and the like) containing a known chelate such as an ethylene diamine tetraacetic acid, a propane diamine tetraacetic acid, a nitrile triacetic acid, a triethylene tetramine hexaacetic acid, and a diethylene triamine pentaacetic acid as a base, and the like.

Furthermore, the supply source of the metal ion may be added not as the aggregating agent but as a mere additive.

It is preferable that the valence of the metal ion becomes higher from the viewpoint of easily forming mesh-shaped ion-crosslinking, the smoothness of the coating film, and the storing properties of the powder coating material. For this reason, Al ion is preferable as the metal ion. That is, an aluminum salt (for example, aluminum sulfate, aluminum chloride, and the like) and an aluminum salt polymer (for example, polyaluminum chloride, polyaluminum hydroxide, and the like) are preferable as the supply source of the metal ion. Further, among the supply sources of the metal ion, an inorganic metal salt polymer is preferable from the viewpoint of the smoothness of the coating film and the storing properties of the powder coating material, compared to the metal salt even at the time of having the same valence of the metal ion. For this reason, the aluminum salt polymer (for example, the polyaluminum chloride, the polyaluminum hydroxide, and the like) is particularly preferable as the supply source of the metal ion.

The content of the metal ion is preferably from 0.002% by weight to 0.2% by weight, and more preferably from 0.005% by weight to 0.15% by weight, with respect to the total content of the powder particles, from the viewpoint of the smoothness of the coating film and the storing properties of the powder coating material.

When the content of the metal ion is 0.002% by weight or more, suitable ion-crosslinking is formed by the metal ion, so that the bleeding of the powder particles is prevented, the storing properties of the coating material easily become higher. On the other hand, when the content of the metal ion is 0.2% by weight or less, the ion-crosslinking is prevented from being excessively formed by the metal ion, and the smoothness of the coating film easily becomes higher.

Here, when the powder particles are prepared by the aggregation and coalescence method, the supply source of the metal ion (a metal salt and a metal salt polymer) added as the aggregating agent contributes to control of the particle diameter distribution and the shape of the powder particles.

Specifically, it is preferable that the valence of the metal ion becomes higher from the viewpoint of obtaining a narrow particle diameter distribution. In addition, the metal salt polymer is preferable from the viewpoint of obtaining a narrow particle diameter distribution, compared to the metal salt even at the time of having the same valence of the metal ion. For this reason, from this viewpoint, the aluminum salt (for example, aluminum sulfate, aluminum chloride, and the like) and the aluminum salt polymer (for example, polyaluminum chloride, polyaluminum hydroxide, and the like) are preferable, and the aluminum salt polymer (for example, the polyaluminum chloride, the polyaluminum hydroxide, and the like) is particularly preferable, as the supply source of the metal ion.

In addition, when the aggregating agent is added such that the content of the metal ion is 0.002% by weight or more, aggregation of the resin particles progresses in an aqueous medium, and thus, contributes to realization of a narrow particle diameter distribution. In addition, aggregation of the resin particles which become the resin coating portion progresses with respect to aggregated particles which become the core, and thus, contributes to realization of formation of the resin coating portion with respect to the entire surface of the core. On the other hand, when the aggregating agent is added such that the content of the metal ion is 0.2% by weight or less, the ion-crosslinking is prevented from being excessively formed in the aggregated particles, and the shape of the powder particles to be formed is easily close to a spherical shape at the time of performing aggregation and coalescence. For this reason, from the viewpoint, the content of the metal ion is preferably from 0.002% by weight to 0.2% by weight, and more preferably from 0.005% by weight to 0.15% by weight.

The content of the metal ion is measured by performing quantitative analysis with respect to intensity of a fluorescent X ray of the powder particles. Specifically, for example, first, the resin and the supply source of the metal ion are mixed, and thus, a resin mixture in which the concentration of the metal ion is already known. A pellet sample is obtained from 200 mg of the resin mixture by using a tablet molding machine having a diameter of 13 mm. The weight of the pellet sample is weighed, intensity of a fluorescent X ray of the pellet sample is measured, and thus, peak intensity is obtained. Similarly, a pellet sample in which the added amount of the supply source of the metal ion is changed is also subjected to measurement, and a calibration curve is prepared from the result thereof. Then, the content of the metal ion in the powder particles which become a measurement target is subjected to quantitative analysis by using the calibration curve.

Examples of an adjustment method of the content of the metal ion include 1) a method of adjusting the added amount of the supply source of the metal ion, 2) a method of adjusting the content of the metal ion by adding the aggregating agent (for example the metal salt or the metal salt polymer) as the supply source of the metal ion in an aggregation step at the time of preparing the powder particles by the aggregation and coalescence method, and then by adding a chelating agent (for example, an ethylene diamine tetraacetic acid (EDTA), a diethylene triamine pentaacetic acid (DTPA), a nitrilotriacetic acid (NTA), and the like) in the final stage of the aggregation step, by forming a complex with the metal ion by the chelating agent, and by removing a complex salt which is formed in the subsequent washing step or the like, and the like.

Other Additives

As the other additives, various additives used in the powder coating material are used.

Specific examples of the other additive include a foam inhibitor (for example, benzoin or benzoin derivatives), a hardening accelerator (an amine compound, an imidazole compound, or a cationic polymerization catalyst), a surface adjusting agent (a leveling agent), a plasticizer, a charge-controlling agent, an antioxidant, a pigment dispersant, a flame retardant, a fluidity-imparting agent, and the like.

Core-Shell Particles

In this exemplary embodiment, the powder particles may be the core-shell particles including the core which contains the thermosetting resin and the thermosetting agent, and the resin coating portion which covers the surface of the core.

At this time, the core may contain the additives other than the colorant described above, if necessary, in addition to the thermosetting resin and the thermosetting agent.

In addition, the resin coating portion of the core-shell particles will be described below.

The resin coating portion may be composed only of a resin, or may contain other components (the thermosetting agent, the other additives, and the like which are described as the components constituting the core).

Here, it is preferable that the resin coating portion is composed only of the resin from the viewpoint of reducing the bleeding. Furthermore, even when the resin coating portion contains other components in addition to the resin, the content of the resin may be 90% by weight or more (preferably, 95% by weight or more) with respect to the total resin coating portion.

The resin constituting the resin coating portion may be a non-curable resin, or may be a thermosetting resin, and it is preferable that the resin is the thermosetting resin from the viewpoint of improving curing density (crosslinking density) of the coating film.

When the thermosetting resin is applied as the resin of the resin coating portion, examples of the thermosetting resin include the same thermosetting resins as those of the core, and preferable examples thereof are identical to those of the thermosetting resin of the core. Here, the thermosetting resin of the resin coating portion may be a resin identical to the thermosetting resin of the core, or may be a resin different from the thermosetting resin of the core.

Furthermore, when the non-curable resin is applied as the resin of the resin coating portion, examples of the non-curable resin preferably include at least one selected from the group consisting of an acrylic resin and a polyester resin.

A coverage of the resin coating portion is preferably from 30% to 100% and more preferably from 50% to 100%, in order to prevent bleeding.

The coverage of the resin coating portion with respect to the surface of the powder particle is a value determined by X-ray photoelectron spectroscopy (XPS) measurement.

Specifically, in the XPS measurement, JPS-9000MX manufactured by JEOL Ltd. is used as a measurement device, and the measurement is performed using a MgKα ray as the X-ray source and setting an accelerating voltage to 10 kV and an emission current to 30 mA.

The coverage of the resin coating portion with respect to the surface of the powder particles is determined by peak separation of a component derived from the material of the core and a component derived from a material of the resin coating portion on the surface of the powder particles, from the spectrum obtained under the conditions described above. In the peak separation, the measured spectrum is separated into each component using curve fitted by the least square method.

As the component spectrum to be a separation base, the spectrum obtained by singly measuring the thermosetting resin, a curing agent, a pigment, an additive, a coating resin used in preparation of the powder particle is used. In addition, the coverage is determined from a ratio of a spectral intensity derived from the coating resin with respect to the total of entire spectral intensity obtained from the powder particles.

A thickness of the resin coating portion is preferably from 0.2 μm to 4 μm and more preferably from 0.3 μm to 3 μm, in order to prevent bleeding.

The thickness of the resin coating portion is a value measured by the following method. The powder particle is embedded in the epoxy resin or the like, and a sliced piece is prepared by performing cutting with a diamond knife. This sliced piece is observed using a transmission electron microscope (TEM) or the like and plural images of the cross section of the powder particles are captured. The thicknesses of 20 portions of the resin coating portion are measured from the images of the cross section of the powder particle, and an average value thereof is used. When it is difficult to observe the resin coating portion in the image of the cross-section due to a clear powder coating material, it is possible to easily perform the measurement by performing dyeing and observation.

Properties of Powder Particles

Volume Average Particle Diameter Distribution Index GSDv

The volume average particle diameter distribution index GSDv of the powder particles is preferably 1.50 or less, is more preferably 1.40 or less, and is even more preferably 1.30 or less, from the viewpoint of the smoothness of the coating film and the storing properties of the powder coating material. When the volume average particle diameter distribution index GSDv is 1.50 or less, deterioration in smoothness of a coating film is prevented.

Volume Average Particle Diameter D50v

In addition, a volume average particle diameter D50v of the powder particles is preferably from 1 μm to 25 μm, is more preferably from 2 μm to 20 μm, and is even more preferably from 3 μm to 15 μm, from the viewpoint of forming a coating film having high smoothness in the small amount.

If a particle diameter of the powder particles contained in the powder coating material is small (for example, a volume average particle diameter is 10 μm or smaller), a coating film having excellent smoothness may be formed, and also, a surface area of the entirety of the powder coating material increases compared to a case of the powder particles having a larger particle diameter. Therefore, the influence of accumulation of charges becomes bigger, and thus the coating film defect (splash marks) is likely to occur. However, according to the present exemplary embodiment, accumulation of charges in the attachment layer is reduced as described above, and therefore the coating film defect (splash marks) is prevented from occurring. From this viewpoint, a volume average particle diameter D50v of the powder particles is further preferably within the range of 4 μm to 10 μm.

Average Circularity

The average circularity of the powder particles is preferably 0.97 or more, is more preferably 0.98 or more, and is even more preferably 0.99 or more.

When the average circularity of the powder particles is 0.97 or more, a surface area of the powder coating material is reduced and a charge amount is reduced, and therefore the coating film defect (splash marks) is prevented from occurring.

Herein, the volume average particle diameter D50v and the volume average particle diameter distribution index GSDv of the powder particles are measured with a Coulter Multisizer II (manufactured by Beckman Coulter, Inc.) and ISOTON-II (manufactured by Beckman Coulter, Inc.) as an electrolyte.

In the measurement, from 0.5 mg to 50 mg of a measurement sample is added to 2 ml of a 5% aqueous solution of surfactant (preferably sodium alkyl benzene sulfonate) as a dispersant. The obtained material is added to 100 ml to 150 ml of the electrolyte.

The electrolyte in which the sample is suspended is subjected to a dispersion treatment using an ultrasonic disperser for 1 minute, and a particle diameter distribution of particles having a particle diameter of 2 μm to 60 μm is measured by a Coulter Multisizer II using an aperture having an aperture diameter of 100 μm. 50,000 particles are sampled.

Cumulative distributions by volume are drawn from the side of the smallest diameter with respect to particle size ranges (channels) separated based on the measured particle diameter distribution. The particle diameter when the cumulative percentage becomes 16% is defined as that corresponding to a volume average particle diameter D16v, while the particle diameter when the cumulative percentage becomes 50% is defined as that corresponding to a volume average particle diameter D50v. Furthermore, the particle diameter when the cumulative percentage becomes 84% is defined as that corresponding to a volume average particle diameter D84v.

A volume average particle diameter distribution index (GSDv) is calculated as (D84v/D16v)^{1/2}.

The average circularity of the powder particles is measured by using a flow type particle image analyzer “FPIA-3000 (manufactured by Sysmex Corporation)”. Specifically, 0.1 ml to 0.5 ml of a surfactant (alkyl benzene sulfonate) as a dispersant is added into 100 ml to 150 ml of water obtained by removing impurities which are solid matter in advance, and 0.1 g to 0.5 g of a measurement sample is further added thereto. A suspension in which the measurement sample is dispersed is subjected to a dispersion process with an ultrasonic dispersion device for 1 minute to 3 minutes, and concentration of the dispersion is from 3,000 particles/μ1 to 10,000 particles/μ1. Regarding this dispersion, the average circularity of the powder particles is measured by using the flow type particle image analyzer.

Herein, the average circularity (Ca) of the powder particles is a value obtained by determining a circularity (Ci) of each of n particles measured for the powder particles and then calculated by the following expression. However, in the following expression, Ci represents a circularity (=circumference length of a circle equivalent to a projected area of the particle/circumference length of a particle projection image), and fi represents frequency of the powder particles.

$$Average Circularity ( Ca ) = ( {\sum }_{i = 1}^{n} ( Ci \times fi ) ) / {\sum }_{i = 1}^{n} ( fi )$$

Method of Preparing Powder Coating Material

Next, a method of preparing the powder coating material according to this exemplary embodiment will be described.

After preparing the powder particles, the powder coating material according to this exemplary embodiment is obtained by externally adding the external additives containing the inorganic particles to the powder particles.

The powder particles may be prepared using any of a dry preparing method (e.g., kneading and pulverizing method) and a wet preparing method (e.g., aggregation and coalescence method, suspension and polymerization method, and dissolution and suspension method). The powder particle preparing method is not particularly limited to these preparing methods, and a known preparing method is employed.

For example, examples of the dry preparing method include 1) a kneading and pulverizing method in which the thermosetting resin and other raw materials are kneaded, pulverized, and classified, a dry preparing method in which the shape of the particles obtained by the kneading and pulverizing method is changed by a mechanical impact force or thermal energy, and the like.

On the other hand, example of the wet preparing method include 1) an aggregation and coalescence method in which a dispersion obtained by performing emulsion polymerization with respect to a polymerizable monomer for obtaining the thermosetting resin and a dispersion of the other raw materials are mixed, aggregated, and heated and coalesced, and thus, the powder particles are obtained, 2) a suspension and polymerization method in which the polymerizable monomer for obtaining the thermosetting resin and a solution of the other raw materials are suspended and polymerized in an aqueous solvent, 3) a dissolution and suspension method in which the thermosetting resin and the solution of the other raw materials are suspended and granulated in the aqueous solvent, and the like. Furthermore, the wet preparing method is able to be preferably used from the viewpoint of a small thermal influence.

In addition, the powder particles being the core-shell particles may be obtained by attaching resin particles to the powder particles obtained by the preparing method described above, which are used as a core, followed by heating and coalescing.

Among them, it is preferable that the powder particles are obtained by the aggregation and coalescence method, from the viewpoint of enabling the volume average particle diameter distribution index GSDv, the volume average particle diameter D50v, and the average circularity to be easily controlled such that the volume average particle diameter distribution index GSDv, the volume average particle diameter D50v, and the average circularity are in the preferable range described above.

Hereinafter, the aggregation and coalescence method of preparing the powder particles which are the core-shell particles will be described as an example.

Specifically, it is preferable that the powder particles are prepared through a step of forming first aggregated particles (a first aggregated particle forming step) by aggregating first resin particles containing a thermosetting resin, and a thermosetting agent in a dispersion in which the first resin particles and the thermosetting agent are dispersed or by aggregating composite particles in a dispersion in which composite particles containing a thermosetting resin and a thermosetting agent are dispersed, a step of forming second aggregated particles (a second aggregated particle forming step) by mixing a first aggregated particle dispersion in which the first aggregated particles are dispersed and a second resin particle dispersion in which second resin particles containing a resin are dispersed, by aggregating the second resin particles on the surface of the first aggregated particles, and by attaching the second resin particles onto the surface of the first aggregated particles, and a step of coalescing the second aggregated particles (a coalescence step) by heating a second aggregated particle dispersion in which the second aggregated particles are dispersed.

Furthermore, in the powder particles prepared by the aggregation and coalescence method, a portion in which the first aggregated particles are coalesced becomes the core, and a portion in which the second resin particles attached onto the surface of the first aggregated particles are coalesced becomes the resin coating portion.

For this reason, powder particles having a single layer structure are able to be obtained insofar as the first aggregated particles formed in the first aggregated particle forming step are supplied to the coalescence step not through the second aggregated particle forming step, and are coalesced instead of the second aggregated particles.

Hereinafter, the details of each of the steps will be described.

Furthermore, in the following description, a preparing method of powder particles containing a colorant will be described, but the colorant is contained, if necessary.

Preparing Step of Each Dispersion

First, each dispersion which is used in the aggregation and coalescence method is prepared.

Specifically, the first resin particle dispersion in which the first resin particles containing the thermosetting resin of the core are dispersed, a thermosetting agent dispersion in which the thermosetting agent is dispersed, a colorant dispersion in which the colorant is dispersed, and the second resin particle dispersion in which the second resin particles containing the resin of the resin coating portion are dispersed are prepared.

In addition, a composite particle dispersion, in which composite particles containing a thermosetting resin for a core and a thermosetting agent are dispersed, is prepared instead of the first resin particle dispersion and the thermosetting agent dispersion.

Furthermore, in each of the steps of the preparing method of the powder coating material, the first resin particles, the second resin particles, and the composite particles will be described by being collectively referred to as “resin particles”, and a dispersion of the resin particles will be described by being referred to as a “resin particle dispersion”.

Herein, a resin particle dispersion is, for example, prepared by dispersing the resin particles in a dispersion medium with a surfactant.

An aqueous medium is used, for example, as the dispersion medium used in the resin particle dispersion.

Examples of the aqueous medium include water such as distilled water, ion exchange water, or the like, alcohols, and the like. The medium may be used alone or in combination of two or more kinds thereof.

Examples of the surfactant include anionic surfactants such as sulfuric ester salt, sulfonate, phosphate ester, and soap anionic surfactants; cationic surfactants such as amine salt and quaternary ammonium salt cationic surfactants; and nonionic surfactants such as polyethylene glycol, alkyl phenol ethylene oxide adduct, and polyol nonionic surfactants. Among these, anionic surfactants and cationic surfactants are particularly used. Nonionic surfactants may be used in combination with anionic surfactants or cationic surfactants.

The surfactants may be used alone or in combination of two or more kinds thereof.

Regarding the resin particle dispersion, as a method of dispersing the resin particles in the dispersion medium, a common dispersing method using, for example, a rotary shearing-type homogenizer, or a ball mill, a sand mill, or a Dyno mill having media is exemplified. Depending on the kind of the resin particles, the resin particles may be dispersed in the resin particle dispersion using, for example, a phase inversion emulsification method.

The phase inversion emulsification method includes: dissolving a resin to be dispersed in a hydrophobic organic solvent in which the resin is soluble; conducting neutralization by adding a base to an organic continuous phase (0 phase); and converting the resin (so-called phase inversion) from W/O to 0/W by adding an aqueous medium (W phase) to form a discontinuous phase, thereby dispersing the resin as particles in the aqueous medium.

Specifically, examples of a preparation method of the resin particle dispersion include the following methods.

For example, when the resin particle dispersion is a polyester resin particle dispersion in which polyester resin particles are dispersed, such a polyester resin particle dispersion is able to be obtained by heating and melting a raw material monomer and by polycondensing the raw material monomer under reduced pressure, and then by adding the obtained polycondensate to a solvent (for example, ethyl acetate) and by dissolving the polycondensate in the solvent, by stirring the obtained dissolved material while adding a weak alkaline aqueous solution thereto, and by performing phase inversion and emulsion with respect to the dissolved material.

Furthermore, when the resin particle dispersion is the composite particle dispersion, the composite particle dispersion is able to be obtained by mixing the thermosetting resin and the thermosetting agent, followed by dispersing in a dispersion medium (for example, performing emulsification such as phase inversion and emulsion).

The volume average particle diameter of the resin particles dispersed in the resin particle dispersion may be, for example, 1 μm or less, and is preferably from 0.01 μm to 1 μm, more preferably from 0.08 μm to 0.8 μm, and even more preferably from 0.1 μm to 0.6 μm.

Regarding the volume average particle diameter of the resin particles, a cumulative distribution by volume is drawn from the side of the smallest diameter with respect to particle size ranges (channels) separated using the particle diameter distribution obtained by the measurement with a laser diffraction-type particle diameter distribution measuring device (for example, LA-700 manufactured by Horiba, Ltd.), and a particle diameter when the cumulative percentage becomes 50% with respect to the entire particles is measured as a volume average particle diameter D50v. The volume average particle diameter of the particles in other dispersions is also measured in the same manner.

Here, in order to prepare the resin particle dispersion, a known emulsion method is able to be used, and a phase inversion emulsification method is effective in which a particle diameter distribution to be obtained is narrow, and a volume average particle diameter is easily in a range of 1 μm or less (in particular, from 0.08 μm to 0.40 μm).

In the phase inversion emulsification method, the resin is dissolved in an organic solvent dissolving the resin, and an independent amphiphilic organic solvent or a mixed solvent, and thus, is in an oil phase. A small amount of basic compound is dropped while stirring the oil phase, water is slightly dropped while further stirring the oil phase, and thus, a water droplet is incorporated in the oil phase. Next, when the dropping amount of water is greater than a certain amount, the oil phase and the water phase are inverted, and thus, the oil phase becomes an oil droplet. After that, a water dispersion is able to be obtained through a desolvation step of depressurization.

The amphiphilic organic solvent indicates a solvent having solubility with respect to water at 20° C. is at least 5 g/L or more, and is preferably 10 g/L or more. When the solubility is less than 5 g/L, an effect of accelerating the speed of an aqueous treatment deteriorates, and storage stability of a water dispersion to be obtained also deteriorates. In addition, examples of the amphiphilic organic solvent include alcohols such as ethanol, n-propanol, isopropanol, n-butanol, isobutanol, sec-butanol, tert-butanol, n-amyl alcohol, isoamyl alcohol, sec-amyl alcohol, tert-amyl alcohol, 1-ethyl-1-propanol, 2-methyl-1-butanol, n-hexanol, and cyclohexanol, ketones such as methyl ethyl ketone, methyl isobutyl ketone, ethyl butyl ketone, cyclohexanone, and isophorone, ethers such as tetrahydrofuran and dioxane, esters such as ethyl acetate, n-propyl acetate, isopropyl acetate, n-butyl acetate, isobutyl acetate, sec-butyl acetate, 3-methoxy butyl acetate, methyl propionate, ethyl propionate, diethyl carbonate, and dimethyl carbonate, glycol derivatives such as ethylene glycol, ethylene glycol monomethyl ether, ethylene glycol monoethyl ether, ethylene glycol monopropyl ether, ethylene glycol monobutyl ether, ethylene glycol ethyl ether acetate, diethylene glycol, diethylene glycol monomethyl ether, diethylene glycol monoethyl ether, diethylene glycol monopropyl ether, diethylene glycol monobutyl ether, diethylene glycol ethyl ether acetate, propylene glycol, propylene glycol monomethyl ether, propylene glycol monopropyl ether, propylene glycol monobutyl ether, propylene glycol methyl ether acetate, and dipropylene glycol monobutyl ether, 3-methoxy-3-methyl butanol, 3-methoxy butanol, acetonitrile, dimethyl formamide, dimethyl acetoamide, diacetone alcohol, acetoethyl acetate, and the like. The solvent is able to be independently used, or two or more types thereof are able to be used by being mixed.

Furthermore, the thermosetting polyester resin as the thermosetting resin is neutralized by a basic compound at the time of being dispersed in a water medium. A neutralization reaction with respect to the carboxyl group of the thermosetting polyester resin is an aqueous starting force, and the aggregation between the particles is easily prevented by an electricity repellent force between the generated carboxyl anions.

Examples of the basic compound include ammonia, an organic amine compound having a boiling point of 250° C. or less, and the like. Preferable examples of the organic amine compound include triethyl amine, N,N-diethyl ethanol amine, N,N-dimethyl ethanol amine, aminoethanol amine, N-methyl-N,N-diethanol amine, isopropyl amine, iminobispropyl amine, ethyl amine, diethyl amine, 3-ethoxy propyl amine, 3-diethyl aminopropyl amine, sec-butyl amine, propyl amine, methyl aminopropyl amine, dimethyl aminopropyl amine, methyl iminobispropyl amine, 3-methoxy propyl amine, monoethanol amine, diethanol amine, triethanol amine, morpholine, N-methyl morpholine, N-ethyl morpholine, and the like.

The basic compound is added in the amount in which the basic compound is able to be at least partially neutralized according to the carboxyl group included in the thermosetting polyester resin, that is, the basic compound is preferably added in the amount of 0.2 times equivalent to 9.0 times equivalent to the carboxyl group, and more preferably added in the amount of 0.6 times equivalent to 2.0 times equivalent to the carboxyl group. When the basic compound is added in the amount of greater than or equal to 0.2 times equivalent to the carboxyl group, an effect of adding the basic compound is easily confirmed. When the basic compound is added in the amount of less than or equal to 9.0 times equivalent to the carboxyl group, the particle diameter distribution hardly widens and an excellent dispersion is able to be easily obtained, and it is considered that this is because hydrophilicity of the oil phase is prevented from excessively increasing.

The content of the resin particles contained in the resin particle dispersion is, for example, preferably from 5% by weight to 50% by weight, and more preferably from 10% by weight to 40% by weight.

For example, the thermosetting agent dispersion and the colorant dispersion are also prepared in the same manner as in the case of the resin particle dispersion. That is, the volume average particle diameter, the dispersion medium, the dispersing method, and the content of the particles of the colorant dispersed in the colorant dispersion and the particles of the thermosetting agent dispersed in the thermosetting agent dispersion are the same as those of the resin particles in the resin particle dispersion.

First Aggregated Particle Forming Step

Next, the first resin particle dispersion, the thermosetting agent dispersion, and the colorant dispersion are mixed with each other.

The first resin particles, the thermosetting agent, and the colorant are heterogeneously aggregated in the mixed dispersion, thereby forming first aggregated particles having a diameter near a target powder particle diameter and including the first resin particles, the thermosetting agent, and the colorant.

Specifically, for example, an aggregating agent is added to the mixed dispersion and a pH of the mixed dispersion is adjusted to be acidic (for example, the pH is from 2 to 5). If necessary, a dispersion stabilizer is added. Then, the mixed dispersion is heated at a temperature of a glass transition temperature of the first resin particles (specifically, for example, from (the glass transition temperature of the first resin particles—30° C.) to (the glass transition temperature thereof—10° C.)) to aggregate the particles dispersed in the mixed dispersion, thereby forming the first aggregated particles.

In the first aggregated particle forming step, the first aggregated particles may be formed by mixing the composite particle dispersion including the thermosetting resin and the thermosetting agent, and the colorant dispersion with each other and heterogeneously aggregating the composite particles and the colorant in the mixed dispersion.

In the first aggregated particle forming step, for example, the aggregating agent may be added at room temperature (for example, 25° C.) while stirring of the mixed dispersion using a rotary shearing-type homogenizer, the pH of the mixed dispersion may be adjusted to be acidic (for example, the pH is from 2 to 5), a dispersion stabilizer may be added if necessary, and the heating may then be performed.

Examples of the aggregating agent include a surfactant having an opposite polarity to the polarity of the surfactant used as the dispersant to be added to the mixed dispersion, metal salt, a metal salt polymer, and a metal complex. When a metal complex is used as the aggregating agent, the amount of the surfactant used is reduced and charging characteristics are improved.

After completing the aggregation, an additive for forming a complex or a similar bond with metal ion of the aggregating agent may be used, if necessary. A chelating agent is suitably used as this additive. With the addition of this chelating agent, the content of the metal ion of the powder particles may be adjusted, when the aggregating agent is excessively added.

Herein, the metal salt, the metal salt polymer, or the metal complex as the aggregating agent is used as a supply source of the metal ions. These examples are as described above.

A water-soluble chelating agent is used as the chelating agent. Specific examples of the chelating agent include oxycarboxylic acids such as tartaric acid, citric acid, and gluconic acid, iminodiacetic acid (IDA), nitrilotriacetic acid (NTA), and ethylenediaminetetraacetic acid (EDTA).

The amount of the chelating agent added may be, for example, from 0.01 parts by weight to 5.0 parts by weight, and is preferably from 0.1 parts by weight or more and less than 3.0 parts by weight with respect to 100 parts by weight of the resin particles.

Second Aggregated Particle Forming Step

Next, the obtained first aggregated particle dispersion in which the first aggregated particles are dispersed is mixed together with the second resin particle dispersion.

The second resin particles may be the same kind as the first resin particles or may be a different kind therefrom.

Aggregation is performed such that the second resin particles are attached to the surface of the first aggregated particles in the mixed dispersion in which the first aggregated particles and the second resin particles are dispersed, thereby forming second aggregated particles in which the second resin particles are attached to the surface of the first aggregated particles.

Specifically, in the first aggregated particle forming step, for example, when the particle diameter of the first aggregated particles reaches a target particle diameter, the second resin particle dispersion is mixed with the first aggregated particle dispersion, and the mixed dispersion is heated at a temperature lower than or equal to the glass transition temperature of the second resin particles.

By setting pH of the mixed dispersion to be in a range of 6.5 to 8.5, for example, the progress of the aggregation is stopped.

Accordingly, the second aggregated particles aggregated in such a way that the second resin particles are attached to the surface of the first aggregated particles are obtained.

Coalescence Step

Next, the second aggregated particle dispersion in which the second aggregated particles are dispersed is heated at, for example, a temperature that is higher than or equal to the glass transition temperature of the first and second resin particles (for example, a temperature that is higher than the glass transition temperature of the first and second resin particles by 10° C. to 30° C.) to coalesce the second aggregated particles and form the powder particles.

The powder particles are obtained through the foregoing step.

Herein, after the coalescence step ends, the powder particles formed in the dispersion are subjected to a washing step, a solid-liquid separation step, and a drying step, that are well known, and thus, dry powder particles are obtained.

In the washing step, preferably displacement washing using ion exchange water is sufficiently performed from the viewpoint of charging properties. In addition, the solid-liquid separation step is not particularly limited, but suction filtration, pressure filtration, or the like is preferably performed from the viewpoint of productivity. The method for the drying step is also not particularly limited, but freeze drying, airflow drying, fluidized drying, vibration-type fluidized drying, or the like is preferably performed from the viewpoint of productivity.

The powder coating material according to this exemplary embodiment is prepared by adding the external additive containing the inorganic particles of which electrical volume resistance is within the above range (and further containing the silica particles if necessary) to the obtained dry powder particles, and then mixing.

The mixing is preferably performed with, for example, a V-BLENDER, a HENSCHEL MIXER, a LODIGE MIXER, or the like.

Furthermore, if necessary, coarse particles of the powder particles may be removed using a vibration sieving machine, a wind classifier, or the like.

Properties of Powder Coating Material

Dielectric Loss Factor

As a dielectric loss factor of the powder coating material according to this exemplary embodiment, from 20×10⁻³ to 150×10⁻³ is preferable, from 30×10⁻³ to 100×10⁻³ is more preferable, and from 50×10⁻³ to 80×10⁻³ is further preferable.

The dielectric loss factor of the powder coating material is measured by the following method.

First, 5 g of the powder coating material is molded into a pellet shape and set between electrodes (SE-71 type solid electrode, manufactured by Ando Electric Co., Ltd.) under conditions of a temperature of 20° C. and relative humidity of 60%, and the dielectric loss factor is measured at 5 V and a frequency of 100 kHz by LCR meter (4274A type, manufactured by Hewlett-Packard Japan, Ltd.).

Furthermore, the dielectric loss factor is obtained by the following Expression (1).

(14.39/(W×D²))×Gx×Tx×10¹² Expression (1)

Here, W represents 2πf (f: measurement frequency of 100 kHz), D represents an electrode diameter (cm), Gx represents electric conductivity (S), and Tx represents a sample thickness (cm).

A dielectric loss factor of the powder coating material may be regulated by compositions of the powder particles, a method for preparing the powder particles, properties of the inorganic particles, and the like. For example, by using the inorganic particles of which electrical volume resistance is within the above range as inorganic particles externally added to the surfaces of the powder particles, regulating a dielectric loss factor within the above range becomes easy.

Electrostatic Powder Coating Method

An electrostatic powder coating method according to this exemplary embodiment includes: a step (hereinafter, referred to as a “coating step”) of jetting out the above-described powder coating material according to this exemplary embodiment which is charged, and attaching (coating) the powder coating material to an object to be coated; and a step (hereinafter, referred to as a “baking step”) of heating the powder coating material which is electrostatically attached to the object to be coated, and forming a coating film.

Hereinafter, each step will be explained.

Coating Step

In the coating step, the charged powder coating material is discharged, and is electrostatically attached (coated) to the object to be coated, and therefore an attachment layer is formed.

Specifically, in the coating step, for example, the charged powder coating material is discharged from a discharge port of the electrostatic powder coating machine in a state where an electrostatic field is formed between the discharge port of a electrostatic powder coating machine and a coating surface of the object to be coated (a surface having conductivity), and the powder coating material is electrostatically attached to a coated surface of the object to be coated, and thus, an attachment layer is coated. That is, for example, a voltage is applied by setting the coated surface of the object to be coated which is grounded to a positive electrode and the electrostatic powder coating machine to a negative electrode, the electrostatic field is formed in both of the electrodes, and the charged powder coating material is electrostatically attached to the coating surface of the object to be coated by being flown, and thus, the film of the powder coating material is formed.

Furthermore, the coating step may be performed while relatively moving the discharge port of the electrostatic powder coating machine and the coating surface of the object to be coated.

Here, for example, a known electrostatic powder coating machine such as a corona gun (a coating machine which discharges a charged powder coating material in corona discharge), a tribo gun (a coating machine which discharges a powder coating material in friction charge), and a bell gun (a coating machine which centrifugally discharges a charged powder coating material in corona discharge or friction charge) is used as the electrostatic powder coating machine. Then, discharge conditions for excellent coating may be a setting range of each of the guns.

The attachment amount of the powder coating material to be attached to the coating surface of the object to be coated may be from 20 g/m² to 100 g/m² (preferably, from 25 g/m² to 50 g/m²) from the viewpoint of preventing a variation in the smoothness of the coating film.

Meanwhile, if the coating film formed on the object to be coated becomes thicker, that is, an attachment amount becomes large (for example, attachment amount of 130 g/m² or more), accumulation of charges becomes easier, and therefore, the coating film defect (splash marks) is likely to occur. However, according to the present exemplary embodiment, accumulation of charges in the attachment layer is reduced as described above, and therefore the coating film defect (splash marks) is prevented from occurring.

Baking Step

In the baking step, the attachment layer is heated, and thus, the coating film is formed. Specifically, the powder particles of the film of the powder coating material are melted and cured by heating, and thus, the coating film is formed.

A heating temperature (a baking temperature) is selected according to the type of powder coating material. As an example, the heating temperature (the baking temperature) is preferably from 90° C. to 250° C., is more preferably from 100° C. to 220° C., and is even more preferably from 120° C. to 200° C. Furthermore, a heating time (a baking time) is adjusted according to the heating temperature (the baking temperature).

Object to be Coated

Here, the object to be coated which is a target product to be coated with the powder coating material is not particularly limited, and examples of the object to be coated include various metal components, ceramic components, resin components, and the like. The target product may be an unmolded product before being molded into each product such as a plate-shaped product and a linear product, or may be a molded product molded for electronic components, road vehicles, interior and exterior architectural materials, and the like. In addition, the target product may be a product of which the surface to be coated is subjected to a surface treatment such as a primer treatment, a plating treatment, and electrodeposition coating.

### EXAMPLES

Hereinafter, this exemplary embodiment will be described in detail with reference to examples, and this exemplary embodiment is not limited to the examples. Furthermore, in the following description, unless otherwise particularly stated, both of “parts” and “%” are based on the weight.

Clear Powder Particles (PC1)

Preparation of Polyester Resin and Curing Agent Composite Dispersion (E1)

A mixed solvent of 180 parts of ethyl acetate and 80 parts of isopropyl alcohol is put into 3 liters of a reaction vessel provided with a jacket (BJ-30N, manufactured by TOKYO RIKAKIKAI CO, LTD.) equipped with a condenser, a thermometer, a water dropping device, and an anchor blade while maintaining the reaction vessel in a water circulation type thermostatic bath at 40° C., and the following compositions are put into the vessel.
Polyester Resin (PES1) [Polycondensate of terephthalic acid/ethylene glycol/neopentyl glycol/trimethylol propane (molar ratio=100/60/38/2 (mol %), glass transition temperature=62° C., acid value (Av)=12 mgKOH/g, hydroxyl value (OHv)=55 mgKOH/g, weight average molecular weight (Mw)=12,000, and number average molecular weight (Mn)=4,000]: 240 parts
Block Isocyanate Curing Agent, VESTAGONB1530 (manufactured by Evonik Japan Co., Ltd.): 60 parts
Benzoin: 1.5 parts
Acrylic Oligomer (ACRONAL 4F, manufactured by BASF SE): 3 parts

After the above components are charged thereinto, the resultant is stirred at 150 rpm with a three-one motor to perform dissolution, thereby preparing an oil phase. A mixed liquid of 1 part of a 10% by weight ammonia aqueous solution and 47 parts of a 5% by weight aqueous solution of sodium hydroxide is added dropwise into the oil phase being stirred over 5 minutes and is mixed for 10 minutes, and then, 900 parts of ion exchange water is further added dropwise thereinto at a rate of 5 parts per a minute, and thus, a phase inversion is performed, thereby obtaining an emulsion.

Immediately, 800 parts of the obtained emulsion and 700 parts of ion exchange water are put into an eggplant 2 L-flask, are set in an evaporator provided with a vacuum control unit (manufactured by TOKYO RIKAKIKAI CO, LTD.) through a trap bulb. The eggplant flask is heated in a hot water bath at 60° C. while being rotated, and a solvent is removed by reducing the pressure to 7 kPa while being careful of bumping. When the collected amount of the solvent becomes 1,100 parts, the pressure returns to the normal pressure (1 atm), and the eggplant flask is cooled, and thus, a dispersion is obtained. There is no solvent odor in the obtained dispersion. The volume average particle diameter of resin particles in the dispersion is 145 nm. After that, 2% by weight of an anionic surfactant (Dowfax2A1, manufactured by The Dow Chemical Company, Amount of Effective Component: 45% by weight) with respect to the resin contained in the dispersion is added and mixed as an effective component, and ion exchange water is added thereto to adjust the solid concentration to 25% by weight. The resultant is designated as a polyester resin and curing agent composite dispersion (E1).

Preparation of Clear Powder Particles (PC1)

Aggregation Step
Polyester Resin and Curing Agent Composite Dispersion (E1): 180 parts (Solid of 45 parts)
Ion Exchange Water: 200 parts

The compositions described above are mixed and dispersed in a round stainless steel flask by using a homogenizer (ULTRA-TURRAX T50, manufactured by IKA Works GmbH & Co.). Next, the pH is adjusted to be 3.5 with an aqueous solution of a nitric acid of 1.0% by weight. 0.50 parts of an aqueous solution containing 10% by weight of polyaluminum chloride is added thereto, and a dispersing operation is continuously performed by using ULTRA-TURRAX.

A stirrer and a mantle heater are disposed, the temperature is increased up to 50° C. while adjusting the number of rotations of the stirrer such that slurry is sufficiently stirred, the slurry is held at 50° C. for 15 minutes, and then the particle diameter of aggregated particles is measured by using [TA-II] type Coulter Counter (manufactured by Beckman Coulter, Inc., Aperture Diameter: 50 μm), and when the volume average particle diameter becomes 5.5 μm, 60 parts of the polyester resin and curing agent composite dispersion (E1) is slowly put into the flask as a shell (the shell is put into the flask).

Coalescence Step

After charging the polyester resin and curing agent composite dispersion (E1) thereinto, the flask is held for 30 minutes, and then, the pH is adjusted to 7.0 with an aqueous solution of sodium hydroxide of 5%. After that, the temperature is increased up to 85° C. and is held for 2 hours.

Filtering, Washing, and Drying Step

After the reaction ends, a solution in the flask is cooled and is filtered, and thus, a solid is obtained. Next, the solid is washed with ion exchange water, and then, solid liquid separation is performed by Nutsche type suction filtration, and thus, a solid is obtained again.

Next, the solid is dispersed again in 3 liters of ion exchange water at 40° C., and is stirred and washed at 300 rpm for 15 minutes. The washing operation is repeated 5 times, the solid obtained by performing the solid liquid separation according to the Nutsche type suction filtration is subjected to vacuum drying for 12 hours, and thus, clear core-shell powder particles (PC1) are obtained.

When a particle diameter of this clear powder particles (PC1) are measured, the volume average particle diameter D50v is 6.4 μm, the volume average particle diameter distribution index GSDv is 1.24, and the average circularity is 0.97.

White Powder Particles (PC2)

Preparation of White Pigment Dispersion (W1)
Titanium Oxide (A-220, manufactured by ISHIHARA SANGYO KAISHA, LTD.): 100 parts
Anionic Surfactant (Neogen RK, manufactured by DKS Co. Ltd.): 15 parts
Ion Exchange Water: 400 parts
Nitric Acid of 0.3 mol/l: 4 parts

The compositions described above are mixed to perform dissolution, and are dispersed for 3 hours by using a high pressure impact type disperser Ultimizer (HJP30006, manufactured by SUGINO MACHINE LIMITED), and thus, a white pigment dispersion including titanium oxides dispersed is prepared. Measurement is performed by using a laser diffraction particle diameter measurement machine, and thus, the volume average particle diameter of the titanium oxide in the pigment dispersion is 0.28 μm, and a solid content ratio of the white pigment dispersion is 25%.

Preparation of White Powder Particles (PC2)

White powder particles (PC2) are prepared in the same manner as in the preparation of the clear powder particles (PC1) except that in the aggregation step of preparing the above clear powder particles (PC1), compositions of the core (that is, compositions before putting the shell in) are changed as described below.

As a result of measuring a particle diameter of this white powder particles (PC2), the volume average particle diameter D50v is 6.8 μm, the volume average particle diameter distribution index GSDv is 1.24, and the average circularity is 0.97.
Polyester Resin and Curing Agent Composite Dispersion (E1): 180 parts (Solid of 45 parts)
White Pigment Dispersion (W1): 160 parts (Solid of 40 parts)
Ion Exchange Water: 200 parts

Kneading and Pulverizing Clear Powder Particles (PC3)
Polyester Resin (PES1) [Polycondensate of terephthalic acid/ethylene glycol/neopentyl glycol/trimethylol propane (molar ratio=100/60/38/2 (mol %), glass transition temperature=62° C., acid value (Av)=12 mgKOH/g, hydroxyl value (OHv)=55 mgKOH/g, weight average molecular weight (Mw)=12,000, and number average molecular weight (Mn)=4,000]: 240 parts
Block Isocyanate Curing Agent VESTAGONB1530 (manufactured by Evonik Japan Co., Ltd.): 60 parts
Benzoin: 1.5 parts
Acrylic Oligomer (Acronal 4F, manufactured by BASF SE): 3 parts

The above compositions are preliminarily mixed in a mixer, and then kneaded while being heated to 100° C. by an extruder, followed by coarse pulverization to obtain flakes. Next, fine pulverization is carried out using a turbo mill aiming at a particle diameter of 6 μm, and classification is carried out to obtain a kneaded and pulverized clear powder coating material (PC3).

As a result of measuring a particle diameter of the kneaded and pulverized clear powder particle (PC3), the volume average particle diameter D50v is 7.5 μm, the volume average particle diameter distribution index GSDv is 1.27, and the average circularity is 0.93.

Fluorine Resin-Containing Powder Particles (PC4)

A dispersion is obtained in the same manner as above except that in the preparation of the polyester resin and the curing agent composite dispersion (E1) of the clear powder particles (PC1), polyester resin (PES 1) is changed to LUMIFLON (registered trademark) FD1000 (manufactured by Asahi Glass Co., Ltd.). A volume average particle diameter of the resin particles in this dispersion is 155 nm. After that, 2% by weight of an anionic surfactant (Dowfax2A1, manufactured by The Dow Chemical Company, Amount of Effective Component: 45% by weight) with respect to the resin of the dispersion is added and mixed as an effective component, and ion exchange water is added thereto to adjust a solid concentration to 25% by weight. The resultant is designated as a fluorine resin and curing agent composite dispersion (E2).

Subsequently, a fluorine resin-containing powder particles (PC4) is obtained in the same manner as above except that in the preparation of the clear powder particles (PC1), the polyester resin and the curing agent composite dispersion (E1) is changed to the fluorine resin and curing agent composite dispersion (E2).

As a result of measuring the particle diameter of the fluorine resin-containing powder particles (PC4), the volume average particle diameter D50v is 6.1 μm, the volume average particle diameter distribution index GSDv is 1.25, and the average circularity is 0.98.

Clear Powder Particles (PC5)

Clear powder particles (PC5) is obtained in the same manner as above except that in the aggregation step of the preparation of the clear powder particles (PC1), when the volume average particle diameter becomes 11 μm, not 5.5 μm, 60 parts of the polyester resin and curing agent composite dispersion (E1) is slowly put into the flask as a shell (the shell is put into the flask).

As a result of measuring the particle diameter of the clear powder particles (PC5), the volume average particle diameter D50v is 12.3 μm, the volume average particle diameter distribution index GSDv is 1.29, and the average circularity is 0.97.

Preparation of Inorganic Particles

The details of the inorganic particles used in the example are shown in the following Table 1.

TABLE 1

| | Volume | | | | | |
|---|---|---|---|---|---|---|
| | Average | | | | Electrical | |
| | Particle | | Aspect | | volume | |
| | Diameter | | Ratio | Particle Composition | resistance | |
| M1 | 15 | nm | 3.5 | Titanium oxide particles | 6 × 10⁷ | Ω · cm |
| | | | | (rutile type) | | |
| | | | | MT150W manufactured by TAYCA | | |
| | | | | CORPORATION | | |
| M2 | 80 | nm | 3.3 | Titanium oxide particles | 3 × 10⁶ | Ω · cm |
| | | | | (rutile type) | | |
| | | | | MT700 manufactured by TAYCA | | |
| | | | | CORPORATION | | |
| M3 | 270 | nm | 3 | Titanium oxide particles | 7 × 10⁵ | Ω · cm |
| | | | | (rutile type) | | |
| | | | | JR manufactured by TAYCA | | |
| | | | | CORPORATION | | |
| M4 | 15 | nm | 6 | Titanium oxide particles | 4 × 10¹⁰ | Ω · cm |
| | | | | (rutile type) | | |
| | | | | TTO-V-3 manufactured by | | |
| | | | | ISHIHARA SANGYO KAISHA, LTD. | | |
| M5 | 35 | nm | 1.1 | Zinc oxide particles | 8 × 10¹¹ | Ω · cm |
| | | | | MZ300 manufactured by TAYCA | | |
| | | | | CORPORATION | | |
| M6 | 20 | nm | 1.05 | Titanium oxide particles | 2 × 10⁸ | Ω · cm |
| | | | | (anatase type) | | |
| | | | | P25 manufactured by Evonik | | |
| | | | | Industries | | |

| | | | |
|---|---|---|---|
| M7 | Titanium oxide particles treated with | 4 × 10¹² | Ω · cm |
| | hydrophobizing agent | | |
| | 10% decylsilane treatment, MT150W manufactured by | | |
| | TAYCA CORPORATION | | |
| M8 | Electro-conductive titanium dioxide FT-1000 | 3 × 10⁴ | Ω · cm |
| | manufactured by ISHIHARA SANGYO KAISHA, LTD. | | |

### Example 1

100 parts of the clear powder particles (PC1), 1.2 parts of the inorganic particles (M1), and 0.5 parts of hydrophobic silica particles (R972, manufactured by Nippon Aerosil Co., Ltd., a hydrophobization degree: 52%) having a volume average particle diameter of 16 nm are mixed by a HENSCHEL MIXER at a peripheral speed of 32 m/s for 10 minutes, and then, coarse particles are removed by using a sieve having a mesh size of 45 μm, and thus, a clear powder coating material is obtained.

### Examples 2 to 10 and Comparative Examples 1 and 2

Hereinafter, powder coating materials are obtained in the same manner as in Example 1 except that the powder particles and the inorganic particles to be used are changed to those which are described in the following Table 2, and the presence of the silica particles is changed as described in the following Table 2.

Electrostatic Powder Coating

Each powder coating material is put into a corona gun XR4-110C manufactured by ASAHI SUNAC CORPORATION.

A corona gun XR4-110C manufactured by ASAHI SUNAC CORPORATION is vertically and horizontally slid with respect to a square test panel (an object to be coated) of 30 cm×30 cm of a mirror finished aluminum plate by a distance of 30 cm from a panel front surface (a distance between the panel and a discharge port of the corona gun), and thus, the powder coating material is discharged and is electrostatically attached to the panel, and therefore an attachment layer is formed. The applied voltage of the corona gun is set to 80 kV, the applied air pressure is set to 0.55 MPa, the discharge amount is set to 200 g/minute, the attachment amount of the powder coating material which is attached to the panel is set to 50 g/m², 90 g/m², 180 g/m², and 220 g/m², and then coating is performed 4 times.

After that, each panel is put into a high temperature chamber having a temperature set to 180° C., and is heated (baked) for 30 minutes.

Evaluation of Coating Film Defect

The respective attachment layers are formed with predetermined attachment amounts, the surfaces of the coating films baked by the above method are observed, and are evaluated according to the following four-grade evaluation. If the evaluation is “1” or “2”, the coating film may withstand practical use. The evaluation results are described in Table 2. In addition, the number of times the coating film defect is observed is shown in Table 2.

Evaluation Standard

1: Coating film defect (splash marks) is not recognized on the surface of the coating film.

2: Slight coating film defect (splash marks) is recognized.

3: Coating film defect (splash marks) is recognized.

4: There is an area where the coating film is not formed on the coated surface, and therefore there is an area where the square test panel is visually recognized.

Evaluation of Light Fastness

The panel, in which the attachment amount of the powder coating material prepared in the evaluation of coating film defect is 50.0 g/m², is irradiated with light (light source: xenon lamp, irradiance: 540 W/m²=100 klux, without a UV cut filter) for 500 hours.

After the irradiation with light is completed, the surface of the coating film is wiped with a cloth containing water, and the evaluation of coating film defect is performed in the same manner as above. The evaluation results are shown in Table 2.

Evaluation of Enantiomerism Property

A reflection image of a fluorescent lamp on the surface of the coating film is observed. It is evaluated “excellent” when the outline of the fluorescent light is clearly visible and “poor” when the outline is blurred. The evaluation results are shown in Table 2.

TABLE 2

| | | | | | Coating film defect (* value | | | | | |
|---|---|---|---|---|---|---|---|---|---|---|
| | | | | | in parentheses shows the | | | | | |
| | | | | | number of defects) | | | | | |
| | | Powder | Inorganic | Silica | Attachment amount (g/m²) | | | | Light | Enantiomerism |
| | | particles | particles | particles | 50 | 90 | 180 | 220 | Fastness | property |
| Example | 1 | PC1 | M1 | Presence | 1 (0) | 1 (0) | 1 (0) | 1 (0) | 1 | Excellent |
| | 2 | PC2 | M1 | Presence | 1 (0) | 1 (0) | 1 (0) | 1 (0) | 1 | Excellent |
| | 3 | PC3 | M1 | Presence | 1 (0) | 1 (0) | 1 (1) | 2 (3) | 1 | Excellent |
| | 4 | PC4 | M1 | Presence | 1 (0) | 1 (0) | 1 (0) | 1 (0) | 1 | Excellent |
| | 5 | PC1 | M2 | Presence | 1 (0) | 1 (0) | 1 (0) | 1 (0) | 1 | Excellent |
| | 6 | PC1 | M3 | Presence | 1 (0) | 1 (0) | 1 (1) | 2 (3) | 1 | Excellent |
| | 7 | PC1 | M4 | Presence | 1 (0) | 1 (0) | 1 (0) | 2 (2) | 1 | Excellent |
| | 8 | PC1 | M5 | Presence | 1 (0) | 1 (0) | 1 (0) | 2 (2) | 1 | Excellent |
| | 9 | PC1 | M6 | Presence | 1 (0) | 1 (0) | 1 (0) | 1 (0) | 2 | Excellent |
| | 10 | PC1 | M1 | None | 1 (0) | 1 (0) | 1 (1) | 2 (4) | 1 | Excellent |
| | 11 | PC5 | M1 | Presence | 1 (0) | 1 (0) | 1 (0) | 1 (0) | 2 | Good |
| Comparative | 1 | PC1 | M7 | Presence | 1 (0) | 1 (1) | 3 (15) | 3 (25) | 1 | Excellent |
| Example | 2 | PC1 | M8 | Presence | 4 (0) | 4 (0) | 4 (0) | 4 (0) | 1 | Poor |

As shown in Table 2, it is apparent that in each example using the powder coating material to which the inorganic particles of which electrical volume resistance is within the range of 1×10⁵ Ω·cm to 1×10¹² Ω·cm are externally added, the coating film defect of the coating film formed is prevented from occurring as compared with each comparative example using the powder coating material whose electrical volume resistance is beyond the above range.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A powder coating material, comprising:
powder particles; and
inorganic particles that are present on surfaces of the powder particles and have an electrical volume resistance of from 1×10⁵ Ω·cm to 1×10¹² Ω·cm.

2. The powder coating material according to claim 1,
wherein a volume average particle diameter with respect to primary particles of the inorganic particles is from 10 nm to 100 nm.

3. The powder coating material according to claim 1,
wherein an aspect ratio of the inorganic particles is from 1 to 5.

4. The powder coating material according to claim 1,
wherein surfaces of the inorganic particles are treated with a hydrophobizing agent.

5. The powder coating material according to claim 1,
wherein a content of the inorganic particles is from 0.1% by weight to 3% by weight with respect to a total weight of the powder particles.

6. The powder coating material according to claim 1,
wherein the inorganic particles are particles of titanium oxide.

7. The powder coating material according to claim 6,
wherein the titanium oxide is a rutile type titanium oxide.

8. The powder coating material according to claim 6,
wherein a content rate of the particles of titanium oxide in the powder particles is 2% by weight or less.

9. The powder coating material according to claim 1, further comprising:
silica particles on the surfaces of the powder particles.

10. The powder coating material according to claim 9,
wherein a hydrophobization degree of the silica particles is 60% or lower.

11. The powder coating material according to claim 9,
wherein a volume average particle diameter with respect to primary particles of the silica particles is from 5 nm to 120 nm.

12. The powder coating material according to claim 9,
wherein a content of the silica particles is from 0.1% by weight to 3.0% by weight with respect to a total weight of the powder particles.

13. The powder coating material according to claim 1,
wherein the powder particles are clear powder particles.

14. The powder coating material according to claim 1,
wherein the powder particles include a thermosetting resin selected from the group consisting of a thermosetting polyester resin, a thermosetting (meth)acrylic resin, a thermosetting fluorine resin, and a thermosetting polyethylene resin.

15. The powder coating material according to claim 14,
wherein the powder particles include a thermosetting polyester resin having a total value of an acid value and a hydroxyl value of from 10 mgKOH/g to 250 mgKOH/g, and a number average molecular weight is from 1,000 to 100,000.

16. The powder coating material according to claim 14,
wherein the powder particles include a thermosetting (meth)acrylic resin having a number average molecular weight of from 1,000 to 20,000.

17. The powder coating material according to claim 14,
wherein a content of the thermosetting resin is from 20% by weight to 99% by weight with respect to a total content of the powder particles.

18. The powder coating material according to claim 1,
wherein the powder particles include a metallic element capable of having a valency of 2 or more.

19. The powder coating material according to claim 18,
wherein a content of the metallic element is from 0.002% by weight to 0.2% by weight with respect to a total content of the powder particles.

20. The powder coating material according to claim 1,
wherein an average circularity of the powder particles is 0.97 or greater.
